(19) United States
(12) Patent Application Publication
(10) Pub. No.: US 2007/0052789 A1
(43) Pub. Date: Mar. 8, 2007

(54) Image generating apparatus

(75) Inventor: Mitsuyasu Asada, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co.,Ltd., Daito-shi (JP)

(21) Appl. No.: 11/513,215

(22) Filed: Aug. 31, 2006

(30) Foreign Application Priority Data
Sep. 5, 2005 (JP) 2005-255883

(51) Int. Cl. B41J 2/325

(52) U.S. Cl. 347/222

(57) ABSTRACT

An image generating apparatus applicable to a structure employing an ink sheet cartridge having an outwardly exposed ink sheet, capable of suppressing ejection of the ink sheet cartridge in printing and capable of suppressing reduction of printing quality is obtained. This image generating apparatus comprises an ink sheet cartridge, a chassis, a first stop member provided outside the chassis for engaging with the ink sheet cartridge and a second stop member provided inside the chassis for engaging with the ink sheet cartridge in printing.

### BACKGROUND OF THE INVENTION

1. Field of the Invention

The present invention relates to an image generating apparatus, and more particularly, it relates to an image generating apparatus comprising an ink sheet cartridge.

2. Description of the Background Art

A thermal transfer printer comprising an ink sheet cartridge is known in general, as disclosed in Japanese Patent Laying-Open No. 2003-89257, for example.

The aforementioned Japanese Patent Laying-Open No. 2003-89257 describes the structure of a thermal transfer printer comprising an ink sheet cartridge, which can be easily ejected from a cartridge mount portion by sliding an ejection member (stop member). In this thermal transfer printer, a rib portion of the ink sheet cartridge is fitted with a stop portion provided on a print head mount. The ejection member is so slid that an inclined portion thereof urges a projection of the ink sheet cartridge in an ejective direction. Thus, the rib portion of the ink sheet cartridge escapes from the stop portion of the print head mount, so that the ink sheet cartridge is ejected. The ejection member can be slid not only in nonprinting, but also in printing.

A thermal transfer printer is generally known as an exemplary image generating apparatus. FIG. 19 is an overall perspective view of an exemplary conventional thermal transfer printer. FIG. 20 is a sectional view of the exemplary conventional thermal transfer printer shown in FIG. 19. The structure of the exemplary conventional thermal transfer printer is described with reference to FIGS. 19 and 20.

As shown in FIGS. 19 and 20, the conventional thermal transfer printer comprises a chassis 101 of metal, a print head 102 (see FIG. 20) for printing, a platen roller 103 (see FIG. 20) arranged oppositely to the print head 102, a feed roller 105 carrying a paper 104, a press roller 106 pressing the feed roller 105 and a stop member 107. An ink sheet cartridge 108 storing an ink sheet 108a for transferring ink to the paper 104 is mounted on the conventional thermal transfer printer. The chassis 101 has first and second side surfaces 101a and 101b, as shown in FIG. 19. A cartridge receiving hole 101c is provided on the second side surface 101b of the chassis 101 for receiving the ink sheet cartridge 108.

As shown in FIG. 19, the stop member 107 is provided outside the second side surface 101b of the chassis 101. This stop member 107 is provided with a support shaft 107a rotatably supporting the stop member 107, an engaging pawl 107b engaging with an engaging portion 108g of the ink sheet cartridge 108, a grip 107c held by a user for lifting the stop member 107 upward (along arrow B) and a spring portion 107d supplying urging force for rotating the engaging pawl 107b of the stop member 107 downward when the user lifts up the stop member 107 through the grip. The stop member 107 has a function of inhibiting the ink sheet cartridge 108 from moving in an ejective direction (along arrow A in FIG. 19).

As shown in FIG. 20, the ink sheet cartridge 108 includes a feed bobbin 108b for feeding the ink sheet 108a and a take-up bobbin 108c for taking up the fed ink sheet 108a. A cartridge case forming the ink sheet cartridge 108 is constituted of a feed bobbin storage portion 108d rotatably storing the feed bobbin 108b, a take-up bobbin storage portion 108e rotatably storing the take-up bobbin 108c and a pair of coupling portions 108f coupling the feed bobbin storage portion 108d and the take-up bobbin storage portion 108e with each other at a prescribed distance. When the feed bobbin storage portion 108d and the take-up bobbin storage portion 108e store the feed bobbin 180b and the take-up bobbin 108c respectively, therefore, the ink sheet 108a wound on the feed bobbin 180b and the take-up bobbin 108c is outwardly exposed on the space of the prescribed distance between the feed bobbin storage portion 108d and the take-up bobbin storage portion 108e. The engaging portion 108g (see FIG. 19) engaging with the engaging pawl 107b of the stop member 107 provided on the second side surface 101b of the chassis 101 is provided on one of the pair of coupling portions 108f. The ink sheet cartridge 108 is provided with a helical compression spring (not shown), which regularly urges the ink sheet cartridge 108 mounted on the thermal transfer printer along arrow A in FIG. 19.

As shown in FIG. 20, the print head 102 has a support shaft 102a forming the rotation center of the print head 102, a head portion 102b, an arm portion 102c and a heat sink portion 102d for radiating heat from the head portion 102b. As shown in FIG. 20, further, the print head 102 is mounted on the first and second side surfaces 101a and 101b of the chassis 101 to be rotatable about the support shaft 102a.

A printing operation of the conventional thermal transfer printer is described with reference to FIG. 20. When the print head 102 rotates along arrow C, the head portion 102b thereof comes into contact with the ink sheet 108a outwardly exposed from the ink sheet cartridge 108, as shown in FIG. 20. When the print head 102 further rotates, the ink sheet 108a comes into contact with the fed paper 104. The head portion 102b of the print head 102 and the platen roller 103 press the ink sheet 108a and the paper 104. In this state, the take-up bobbin 108c takes up the ink sheet 108a, while the feed roller 105 carries the paper 104 in a paper discharge direction (along arrow D in FIG. 20). At this time, the head portion 102b of the print head 102 generates heat, to melt the ink of the ink sheet 108a. Thus, the ink is transferred from the ink sheet 108a to the paper 104, for printing an image on the paper 104.

An operation of ejecting the ink sheet cartridge 108 from the conventional thermal transfer printer is described with reference to FIG. 19. When the ink sheet cartridge 108 is mounted on the thermal transfer printer, the engaging portion 108g of the ink sheet cartridge 108 and the engaging pawl 107b of the stop member 107 engage with each other, as shown in FIG. 19. The helical compression spring (not shown) regularly urges the ink sheet cartridge 108 along arrow A. When the user lifts the stop member 107 upward (along arrow B) through the grip 107c, the engaging portion 108g of the ink sheet cartridge 108 and the engaging pawl 107b of the stop member 107 disengage from each other. Thus, the ink sheet cartridge 108 jumps out of the thermal transfer printer along arrow A in FIG. 19, due to the urging force of the helical compression spring (not shown). Thereafter the user ejects the ink sheet cartridge 108 by manually extracting the same from the ink sheet cartridge receiving hole 101c of the chassis 101.

In the conventional thermal transfer printer shown in FIGS. 19 and 20, however, the user can eject the ink sheet cartridge 108 as described above also in printing since the stop member 107 for ejecting the ink sheet cartridge 108 is provided outside the second side surface 101b of the chassis 101. If the user accidentally ejects the ink sheet cartridge 108 during the aforementioned printing operation, therefore, the ink sheet 108a pressed by the head portion 102b of the print head 102 and the platen roller 103 may be broken, or the ink sheet 108a may be entangled in the thermal transfer printer to cause a failure in the thermal transfer printer.

In the thermal transfer printer described in the aforementioned Japanese Patent Laying-Open No. 2003-89257, the ejection member for ejecting the ink sheet cartridge is sidable not only in nonprinting but also in printing. If the user accidentally slides the ejection member in printing, therefore, the ink sheet may be broken, or maybe entangled in the thermal transfer printer to cause a failure in the thermal transfer printer.

In this regard, various thermal transfer printers capable of suppressing ejection of ink sheet cartridges in printing are proposed in general, as disclosed in Japanese Patent Laying-Open Nos. 2001-38976, 11-268315 (1999) and 2-81661 (1990), for example.

The aforementioned Japanese Patent Laying-Open No. 2001-38976 proposes a thermal transfer printer, comprising an ink sheet cartridge, capable of suppressing ejection of the ink sheet cartridge in printing. In this thermal transfer printer, a projecting portion is provided on a free end of a cantilevered print head mount. The print head mount is provided with a print head, which is pressed by a platen roller in printing so that the print head mount is deflected to move the free end. Thus, the projecting portion of the print head mount engages with an end surface of the ink sheet cartridge, for suppressing ejection of the ink sheet cartridge. The ink sheet cartridge is provided with a grab, so that the user ejects the ink sheet cartridge by pulling this grab.

The aforementioned Japanese Patent Laying-Open No. 11-268315 proposes a thermal transfer printer, comprising an ink sheet cartridge, having a cartridge ejection preventing portion provided on a rotating arm rotating a print head. In this thermal transfer printer, the cartridge ejection preventing portion engages with a cartridge engaging member suppressing ejection of the ink sheet cartridge following rotation of the print head. Thus, thermal transfer printer can so inhibit the cartridge engaging member from rotation that it is difficult for the user to rotate the same, whereby the thermal transfer printer can suppress ejection of the ink sheet cartridge in printing. When the user operates the cartridge engaging member engaging with the cartridge ejection preventing portion in the thermal transfer printer proposed in Japanese Patent Laying-Open No. 11-268315, urging force is applied to the rotating arm.

The aforementioned Japanese Patent Laying-Open No. 2-81661 proposes a thermal transfer printer, provided with an ink sheet cartridge having an unexposed ink sheet, capable of suppressing ejection of the ink sheet cartridge through engagement of an engaging portion rotating following rotation of a loading arm for ejecting a take-up bobbin from a cartridge case for outwardly exposing the ink sheet with a notch provided on the ink sheet cartridge. In this thermal transfer printer, the loading arm ejects the take-up bobbin from the ink sheet cartridge in printing, thereby suppressing ejection of the ink sheet cartridge during the printing.

In the thermal transfer printer proposed in the aforementioned Japanese Patent Laying-Open No. 2001-38976, however, urging force is disadvantageously applied to the print head mount engaging with the end surface of the ink sheet cartridge when the user pulls the grab of the ink sheet cartridge in printing. Therefore, the position of the print head provided on the print head mount deviates in printing, to disadvantageously reduce printing quality.

In the thermal transfer printer proposed in the aforementioned Japanese Patent Laying-Open No. 11-268315, urging force is disadvantageously applied to the rotating arm through the cartridge ejection preventing portion when the user operates the cartridge engaging member in printing. Therefore, the position of the print head deviates in printing to reduce printing quality, similarly to the aforementioned Japanese Patent Laying-Open No. 2001-38976.

The thermal transfer printer proposed in the aforementioned Japanese Patent Laying-Open No. 2-81661, provided with the engaging portion engaging with the notch of the ink sheet cartridge and rotating following rotation of the loading arm ejecting the take-up bobbin from the cartridge, presupposes the structure having the loading arm for ejecting the take-up bobbin from the cartridge case. Therefore, it is disadvantageously difficult to apply the structure of the thermal transfer printer proposed in the aforementioned Japanese Patent Laying-Open No. 2-81661 to a thermal transfer printer employing an ink sheet cartridge having a regularly outwardly exposed ink sheet, from which no take-up bobbin may be ejected.

### SUMMARY OF THE INVENTION

The present invention has been proposed in order to solve the aforementioned problems, and an object of the present invention is to provide an image generating apparatus applicable to a structure employing an ink sheet cartridge having an outwardly exposed ink sheet, capable of suppressing ejection of the ink sheet cartridge in printing and capable of suppressing reduction of printing quality.

In order to attain the aforementioned object, an image generating apparatus according to a first aspect of the present invention comprises an ink sheet cartridge including a cartridge case provided with a feed bobbin storage portion and a take-up bobbin storage portion coupled with each other through a pair of coupling portions at a prescribed interval, a feed bobbin and a take-up bobbin stored in the cartridge case and an ink sheet outwardly exposed between the feed bobbin storage portion and the take-up bobbin storage portion, a chassis mounted with the ink sheet cartridge, a first stop member provided outside the chassis for engaging with the ink sheet cartridge and a second stop member provided inside the chassis for engaging with the ink sheet cartridge in printing.

The image generating apparatus according to the first aspect, comprising the cartridge case provided with the feed bobbin storage portion and the take-up bobbin storage portion coupled with each other through the pair of coupling portions at the prescribed interval, the feed bobbin and the take-up bobbin stored in the cartridge case and the ink sheet outwardly exposed between the feed bobbin storage portion and the take-up bobbin storage portion as hereinabove described, has the first stop member provided outside the chassis and the second stop member provided inside the chassis for engaging with the ink sheet cartridge in printing so that the same can suppress ejection of the ink sheet cartridge in printing due to engagement between the second stop member and the ink sheet cartridge in the chassis, also when a user disengages the first stop member provided outside the chassis and the ink sheet cartridge from each other in printing. Consequently, the image generating apparatus can suppress breakage of the ink sheet, and can prevent a failure resulting from entanglement of the ink sheet therein. Further, the image generating apparatus comprising the ink sheet cartridge including the outwardly exposed ink sheet is so formed with the second stop member provided inside the chassis that the user can be inhibited from touching the second stop member, whereby the second stop member can be prevented from application of a load in printing. Thus, the image generating apparatus can prevent members provided inside the chassis from application of a load in printing, thereby suppressing reduction of printing quality.

The aforementioned image generating apparatus according to the first aspect preferably further comprises a print head for printing, a platen roller arranged on a position opposite to the print head and a press member pressing the print head against the platen roller, and the second stop member is preferably mounted on a rotating shaft of the press member. According to this structure, the image generating apparatus can rotate the second stop member following rotation of the press member rotating the print head in printing, whereby the second stop member can engage with the ink sheet cartridge in printing without a dedicated drive source. Consequently, the image generating apparatus can easily suppress ejection of the ink sheet cartridge in printing.

In the aforementioned image generating apparatus comprising the print head, the platen roller and the press member, the second stop member is preferably unidly mounted with respect to the rotating shaft. According to this structure, the second stop member can unidly rotate with respect to the rotating shaft of the press member rotating the print head in printing following rotation of the rotating shaft, whereby the second stop member can easily engage with the ink sheet cartridge in printing.

In this case, an oval stop member insert portion is preferably provided on a portion of the rotating shaft mounted with the second stop member, and an oval rotating shaft receiving hole is preferably provided on a portion of the second stop member receiving the rotating shaft. According to this structure, the second stop member can be easily unidly mounted with respect to the rotating shaft by inserting the oval stop member insert portion of the rotating shaft into the oval rotating shaft receiving hole of the second stop member.

In the aforementioned image generating apparatus according to the first aspect, the ink sheet cartridge is preferably provided with an engaging portion engaging with the second stop member. According to this structure, the second stop member can easily engage with the engaging portion of the ink sheet cartridge, thereby easily suppressing ejection of the ink sheet cartridge.

In the aforementioned image generating apparatus having the ink sheet cartridge provided with the engaging portion engaging with the second stop member, the engaging portion of the ink sheet cartridge preferably includes a groove portion engaging with both surfaces of the second stop member. According to this structure, the image generating apparatus can inhibit the ink sheet cartridge from movement not only in an ejective direction but also in a direction opposite thereto. Thus, the image generating apparatus can suppress reduction of printing quality resulting from misregistration in the direction opposite to the ejective direction for the ink sheet.

In the aforementioned image generating apparatus having the ink sheet cartridge provided with the engaging portion including the groove portion engaging with both surfaces of the second stop member, the ink sheet cartridge preferably further includes a multicolor ink sheet, and the second stop member preferably rotates following rotation of the print head and engages with the groove portion while the print head vertically rotates for printing the multicolor ink sheet. According to this structure, the image generating apparatus can suppress ejection of the ink sheet cartridge also when the user disengages the first stop member and the ink sheet cartridge from each other while the print head separates from the platen roller upon completion of printing in each color. Thus, the image generating apparatus can suppress imperfect completion of printing resulting from ejection of the ink sheet cartridge in an intermediate stage of printing in each color.

In this case, the groove portion preferably has a slender shape. According to this structure, the image generating apparatus can so increase the area of the groove portion engaging with the second stop member as to inhibit the second stop member from disengaging from the slender groove portion when the print head rotates to separate from the platen roller upon completion of printing in each color. Thus, the second stop member can easily engage with the groove portion also when the print head separates from the platen roller upon completion of printing in each color.

In the aforementioned image generating apparatus having the ink sheet cartridge provided with the engaging portion including the groove portion engaging with both surfaces of the second stop member, the groove portion is preferably provided on either coupling portion of the ink sheet cartridge. According to this structure, the groove portion is so located around a central portion between the take-up bobbin storage portion and the feed bobbin storage portion that the second stop member can engage with the groove portion around the central portion between the take-up bobbin storage portion and the feed bobbin storage portion. Therefore, the second stop member can inhibit the ink sheet cartridge from movement around the central portion between the take-up bobbin storage portion and the feed bobbin storage portion of the ink sheet cartridge, whereby the image generating apparatus can more stably inhibit the ink sheet cartridge from movement as compared with a case of inhibiting the ink sheet cartridge from movement on the side of the feed bobbin storage portion or the take-up bobbin storage portion.

In the aforementioned image generating apparatus having the ink sheet cartridge provided with the engaging portion engaging with the second stop member, a portion of the second stop member engaging with the engaging portion of the ink sheet cartridge is preferably arcuately formed. According to this structure, the second stop member can so easily partially engage with the engaging portion that the image generating apparatus can easily keep the second stop member and the engaging portion in engagement also when the print head vertically rotates in printing.

An image generating apparatus according to a second aspect comprises an ink sheet cartridge including a cartridge case provided with a feed bobbin storage portion and a take-up bobbin storage portion coupled with each other through a pair of coupling portions at a prescribed interval, a feed bobbin and a take-up bobbin stored in the cartridge case and a multicolor ink sheet outwardly exposed between the feed bobbin storage portion and the take-up bobbin storage portion, a chassis mounted with the ink sheet cartridge, a print head for printing, a platen roller arranged on a position opposite to the print head, a press member pressing the print head against the platen roller, a first stop member provided outside the chassis for engaging with the ink sheet cartridge and a second stop member provided inside the chassis for engaging with the ink sheet cartridge in printing, the ink sheet cartridge is provided with a groove portion engaging with both surfaces of the second stop member, the groove portion is provided on either coupling portion of the ink sheet cartridge, the second stop member is mounted on a rotating shaft of the press member for rotating following rotation of the print head and engaging with the groove portion while the print head vertically rotates for printing the multicolor ink sheet, and a portion of the second stop member engaging with the ink sheet cartridge is arcuately formed.

The image generating apparatus according to the second aspect, comprising the cartridge case provided with the feed bobbin storage portion and the take-up bobbin storage portion coupled with each other through the pair of coupling portions at the prescribed interval, the feed bobbin and the take-up bobbin stored in the cartridge case and the ink sheet outwardly exposed between the feed bobbin storage portion and the take-up bobbin storage portion as hereinabove described, has the first stop member provided outside the chassis and the second stop member provided inside the chassis for engaging with the ink sheet cartridge in printing so that the same can suppress ejection of the ink sheet cartridge in printing due to engagement between the second stop member and the ink sheet cartridge in the chassis, also when a user disengages the first stop member provided outside the chassis and the ink sheet cartridge from each other in printing. Consequently, the image generating apparatus can suppress breakage of the ink sheet, and can prevent a failure resulting from entanglement of the ink sheet therein. Further, the image generating apparatus comprising the ink sheet cartridge including the outwardly exposed ink sheet is so formed with the second stop member provided inside the chassis that the user can be inhibited from touching the second stop member, whereby the second stop member can be prevented from application of a load in printing. Thus, the image generating apparatus can prevent members provided inside the chassis from application of a load in printing, thereby suppressing reduction of printing quality. In addition, the image generating apparatus can rotate the second stop member following rotation of the press member rotating the print head in printing, whereby the second stop member can engage with the ink sheet cartridge in printing without a dedicated drive source. Consequently, the image generating apparatus can easily suppress ejection of the ink sheet cartridge in printing.

According to the second aspect, further, the image generating apparatus, having the ink sheet cartridge provided with the groove portion engaging with both surfaces of the second stop member, can inhibit the ink sheet cartridge from movement not only in an ejective direction but also in a direction opposite thereto. Thus, the image generating apparatus can suppress reduction of printing quality resulting from misregistration in the direction opposite to the ejective direction for the ink sheet. In addition, the second stop member rotates following rotation of the print head and engages with the groove portion while the print head vertically rotates for printing the multicolor ink sheet, whereby the image generating apparatus can suppress ejection of the ink sheet cartridge also when the user disengages the first stop member and the ink sheet cartridge from each other while the print head separates from the platen roller upon completion of printing in each color. Thus, the image generating apparatus can suppress imperfect completion of printing resulting from ejection of the ink sheet cartridge in an intermediate stage of printing in each color. Further, the groove portion, provided on either coupling portion of the ink sheet cartridge, is so located around a central portion between the take-up bobbin storage portion and the feed bobbin storage portion that the second stop member can engage with the groove portion around the central portion between the take-up bobbin storage portion and the feed bobbin storage portion. Therefore, the second stop member can inhibit the ink sheet cartridge from movement around the central portion between the take-up bobbin storage portion and the feed bobbin storage portion of the ink sheet cartridge, whereby the image generating apparatus can more stably inhibit the ink sheet cartridge from movement as compared with a case of inhibiting the ink sheet cartridge from movement on the side of the feed bobbin storage portion or the take-up bobbin storage portion. Further, the portion of the second stop member engaging with the ink sheet cartridge is arcuately formed, whereby the second stop member can so easily partially engage with the groove portion that the image generating apparatus can easily keep the second stop member and the groove portion in engagement also when the print head vertically rotates in printing.

In the aforementioned image generating apparatus according to the second aspect, the second stop member is preferably unidly mounted with respect to the rotating shaft. According to this structure, the second stop member can unidly rotate with respect to the rotating shaft of the press member rotating the print head in printing following rotation of the rotating shaft, so that the second stop member can easily engage with the ink sheet cartridge in printing.

In this case, an oval stop member insert portion is preferably provided on a portion of the rotating shaft mounted with the second stop member, and an oval rotating shaft receiving hole is preferably provided on a portion of the second stop member receiving the rotating shaft. According to this structure, the second stop member can be easily unidly mounted with respect to the rotating shaft by inserting the oval stop member insert portion of the rotating shaft into the oval rotating shaft receiving hole of the second stop member.

In the aforementioned image generating apparatus according to the second aspect, the groove portion preferably has a slender shape. According to this structure, the image generating apparatus can so increase the area of the groove portion engaging with the second stop member as to inhibit the second stop member from disengaging from the slender groove portion when the print head rotates to separate from the platen roller upon completion of printing in each color. Thus, the second stop member can easily engage with the groove portion also when the print head separates from the platen roller upon completion of printing in each color.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a thermal transfer printer according to an embodiment of the present invention;

FIG. 2 is a front elevational view of the thermal transfer printer according to the embodiment shown in FIG. 1;

FIG. 3 is a perspective view of the thermal transfer printer according to the embodiment shown in FIG. 1, mounted with an ink sheet cartridge;

FIG. 4 is a front elevational view showing a stepping motor and respective gears of the thermal transfer printer according to the embodiment shown in FIG. 1;

FIG. 5 is a perspective view of the thermal transfer printer according to the embodiment shown in FIG. 1, mounted with the ink sheet cartridge;

FIG. 6 is a front elevational view showing a stop member of the thermal transfer printer according to the embodiment shown in FIG. 1;

FIGS. 7 and 8 are perspective views showing the structure of a head press member of the thermal transfer printer according to the embodiment shown in FIG. 1;

FIG. 9 is an overall perspective view of the ink sheet cartridge mounted on the thermal transfer printer according to the embodiment shown in FIG. 1;

FIG. 10 is a plan view of the ink sheet cartridge mounted on the thermal transfer printer according to the embodiment shown in FIG. 1;

FIG. 11 is another overall perspective view of the ink sheet cartridge mounted on the thermal transfer printer according to the embodiment shown in FIG. 1;

FIG. 12 is a plan view showing the internal structure of the ink sheet cartridge mounted on the thermal transfer printer according to the embodiment shown in FIG. 1;

FIG. 13 is a sectional view showing the internal structure of the thermal transfer printer according to the embodiment shown in FIG. 1;

FIGS. 14 to 18 are sectional views for illustrating a printing operation of the thermal transfer printer according to the embodiment shown in FIG. 1;

FIG. 19 is an overall perspective view of an exemplary conventional thermal transfer printer, mounted with an ink sheet cartridge; and

FIG. 20 is a sectional view of the exemplary conventional thermal transfer printer shown in FIG. 19.

### DESCRIPTION OF THE PREFERRED EMBODIMENTS

An embodiment of the present invention is now described with reference to the drawings.

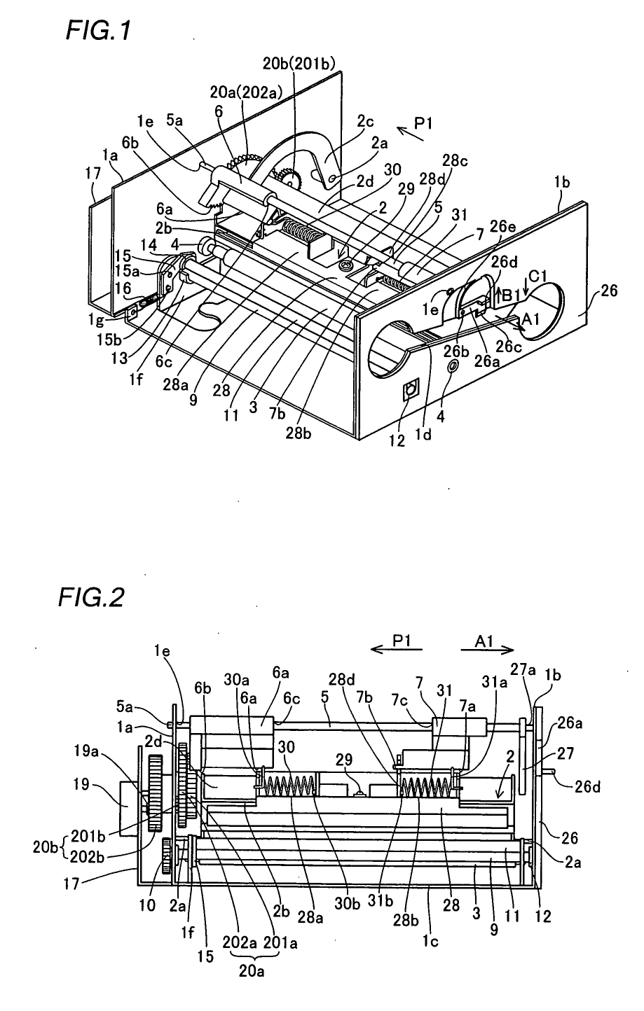

The structure of a thermal transfer printer according to this embodiment is described with reference to FIGS. 1 to 13. According to this embodiment, the present invention is applied to the thermal transfer printer, which is an exemplary image generating apparatus.

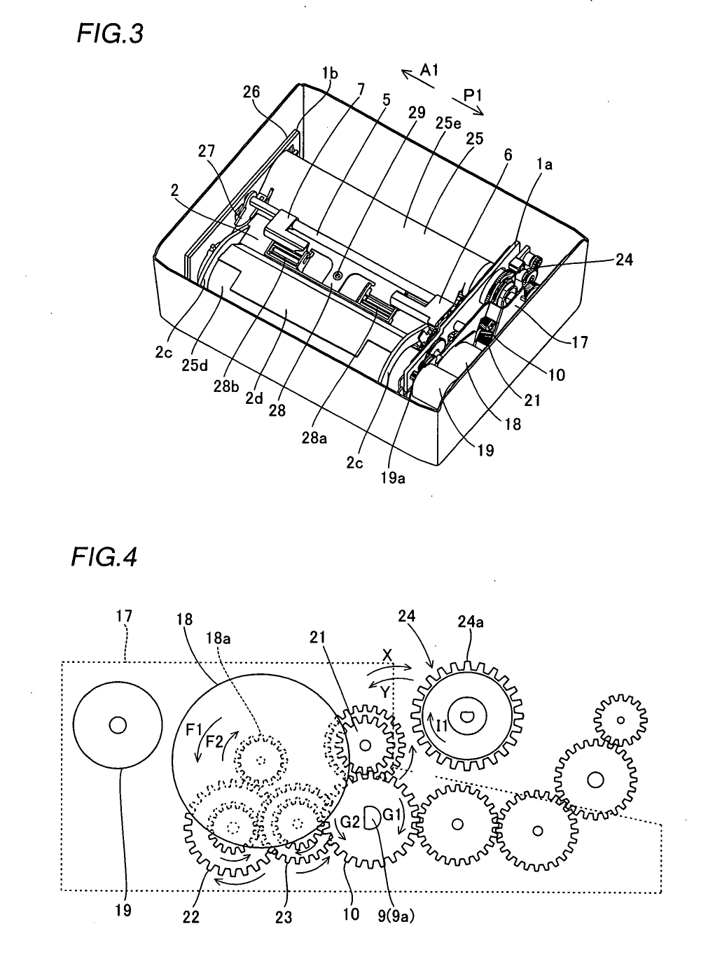

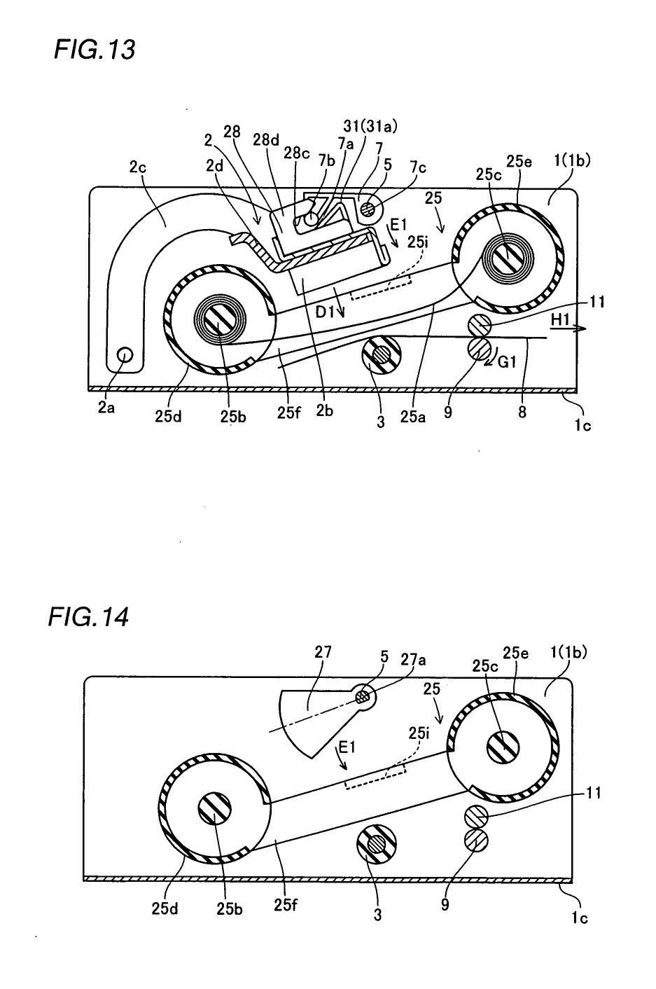

As shown in FIGS. 1 to 4 and 13, the thermal transfer printer according to this embodiment comprises a chassis 1 of metal, a print head 2 for printing, a platen roller 3 arranged oppositely to the print head 2, two platen roller bearings 4 rotatably supporting the platen roller 3, a support rod 5 of metal, head portion press members 6 and 7 for pressing the print head 2, a feed roller 9 of metal for carrying a paper 8 (see FIG. 13), a feed roller gear 10 (see FIG. 4), a press roller 11 of metal pressing the feed roller 9 with prescribed pressing force, feed roller bearings 12 and 13 rotatably supporting the feed roller 9, press roller bearings 14 rotatably supporting the press roller 11, bearing support plates 15, helical tension springs 16 for urging the press roller 11 with pressing force, a motor bracket 17, a paper feed motor 18 (see FIG. 4) for driving the feed roller 9 etc., a motor gear 18a (see FIG. 4), a press member rotating motor 19 (see FIG. 4) for driving the head portion press members 6 and 7, a drive gear 20a, an intermediate gear 20b, a swing gear 21 (see FIG. 4), intermediate gears 22 and 23 (see FIG. 4) and a take-up reel 24. An ink sheet cartridge 25 (see FIG. 3) of resin storing ink sheets 25a is mounted on the thermal transfer printer according to this embodiment. The support rod 5 is an example of the “rotating shaft” in the present invention, and the head portion press members 6 and 7 are examples of the “press member” in the present invention.

As shown in FIG. 1, the chassis 1 has first and second side surfaces 1a and 1b and a bottom surface 1c. The aforementioned motor bracket 17 is mounted on the first side surface 1a of the chassis 1a. A cartridge receiving hole 1d for receiving the ink sheet cartridge 25 is provided on the second side surface 1b of the chassis 1 opposed to the first side surface 1a. The feed roller bearing 12 supporting a first end of the feed roller 9 is also provided on the second side surface 1b of the chassis 1. Further, a side plate 26 integrally provided with a stop portion 26a for inhibiting the ink sheet cartridge 25 from moving in an ejective direction (along arrow A1 in FIG. 1) is mounted outside the second side surface 1b of the chassis 1. The stop portion 26a is provided with a support shaft 26b rotatably supporting the stop portion 26a, an engaging pawl 26c engaging with an engaging portion 25h of the ink sheet cartridge 25, a grip 26d held by a user for lifting the stop portion 26a upward (along arrow B1) and a spring portion 26e supplying urging force for rotating the engaging pawl 26c of the stop portion 26a downward (along arrow C1) when the user lifts up the stop portion 26a through the grip 26d. The stop portion 26a is so formed that the user can eject the ink sheet cartridge 25 by lifting up the stop portion 26a through the grip 26d. The stop portion 26a is an example of the “first stop member” in the present invention. Support holes 1e are provided on the first and second side surfaces 1a and 1b of the chassis 1 respectively, for rotatably supporting the support rod 5 mounted with the head portion press members 6 and 7. A bent section if is provided on the bottom surface 1c of the chassis 1 by partially uprighting the bottom surface 1c. The feed roller bearing 13 supporting a second end of the feed roller 9 is provided on this bent section 1f, as shown in FIG. 1. A spring mount portion 1g mounted with a first end of the helical tension spring 16 is provided on the bottom surface 1c of the chassis 1, as shown in FIG. 1.

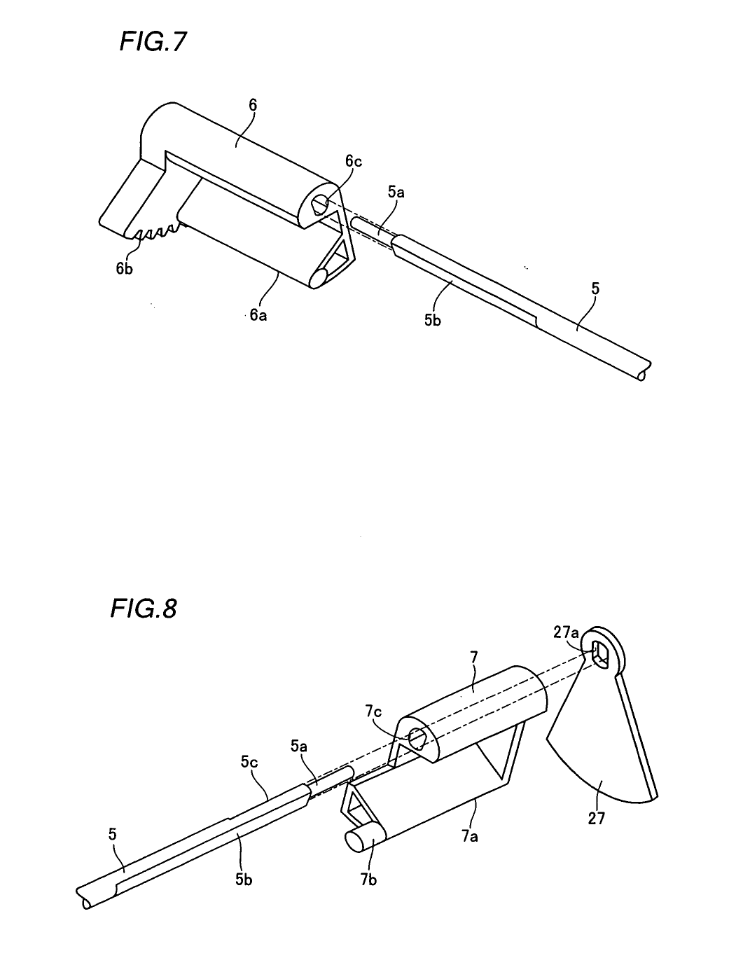

As shown in FIGS. 7 and 8, first and second support portions 5a are provided on first and second ends of the support portion 5 respectively. The first and second support portions 5a of the support rod 5 are fitted into the support holes 1e provided on the first and second side surfaces 1a and 1b of the chassis 1 respectively. As shown in FIGS. 7 and 8, further, the head portion press members 6 and 7 are mounted on the first and second ends of the support rod 5 respectively, unidly with respect to the support rod 5. More specifically, D-shaped insert portions 5b are provided in the vicinity of both ends of the support rod 5 respectively, as shown in FIGS. 7 and 8. An oval stop member insert portion 5c press-fitted into a stop member 27 is provided on the second end of the support rod 5.

As shown in FIG. 7, the head portion press member 6 is integrally formed with a press portion 6a and a gear portion 6b. As shown in FIG. 8, the head portion press member 7 is integrally formed with a press portion 7a and a projection 7b protruding in the extensional direction of the support rod 5.

The head portion press members 6 and 7 are formed with D-shaped receiving holes 6c and 7c receiving the insert portions 5b provided in the vicinity of both ends of the support rod 5 respectively. Upon rotation of the head portion press member 6, therefore, the support rod 5 rotates, followed by rotation of the head portion press member 7. The head portion press members 6 and 7 are arranged on the sides of the first and second side surfaces 1a and 1b of the chassis 1 respectively, as shown in FIGS. 1 and 2.

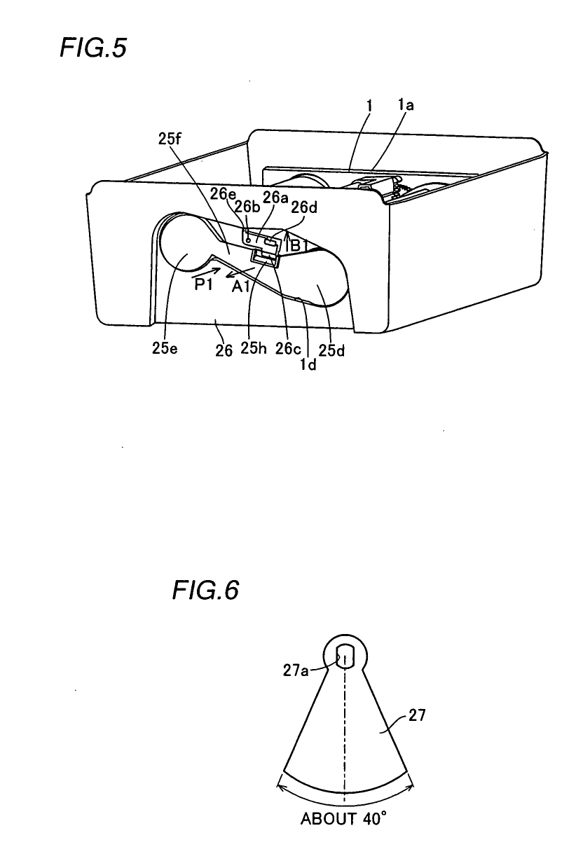

According to this embodiment, the stop member 27 of resin is mounted on the second end of the support rod 5. A portion of the stop member 27 engaging with the ink sheet cartridge 25 is arcuately formed, as shown in FIG. 6. The arcuately formed portion of the stop member 27 has an angle of about 400. Further, the stop member 27 is provided with an oval support rod receiving hole 27a, into which the support rod 5 is press-fitted. The stop member 27 is unidly mounted on the support rod 5. Upon rotation of the head portion press members 6 and 7, therefore, the stop member 27 rotates in association with the head portion press members 6 and 7. The stop member 27 is provided inside the second side surface 1b of the chassis 1, so that the user cannot touch the same. The stop member 27 is an example of the “second stop member” in the present invention, and the support rod receiving hole 27a is an example of the “rotating shaft receiving hole” in the present invention.

As shown in FIGS. 1 and 13, the print head 2 has a pair of support shafts 2a, a head portion 2b (see FIG. 13), a pair of arm portions 2c coupling the support shafts 2a and the head portion 2b with each other and a heat sink portion 2d of aluminum for radiating heat from the head portion 2b. The pair of support shafts 2a of the print head 2 are vertically rotatably mounted on the inner surfaces of the first and second side surfaces 1a and 1b of the chassis 1 respectively. The platen roller 3 is rotatably supported by the two platen roller bearings 4 (see FIG. 1) mounted on the first and second side surfaces 1a and 1b of the chassis 1 respectively.

As shown in FIGS. 1 and 2, a spring holder 28 is fixed to the upper surface of the heat sink portion 2d of the print head 2 with a screw 29. This spring holder 28 is provided with two spring fixing portions 28a and 28b mounted with two torsion coil springs 30 and 31 respectively. The torsion coil spring 30 has a first end 30a pressed against the press portion 6a of the head portion press member 6 upon downward rotation of the head portion press member 6 and a second end 30b transmitting urging force resulting from the pressed first end 30a to the head portion 2b. The torsion coil spring 31 also has a first end 31a pressed against the press portion 7a of the head portion press member 7 upon downward rotation of the head portion press member 7 and a second end 31b transmitting urging force resulting from the pressed first end 31a to the head portion 2b. The head portion 2b is pressed against the platen roller 3 due to the urging force of the torsion coil springs 30 and 31 transmitted thereto.

As shown in FIGS. 1 and 13, the spring fixing portion 28b of the spring holder 28 is integrally formed with an engaging portion 28d having a notch 28c engaging with the projection 7b of the head portion press member 7. When the head portion press member 7 upwardly rotates, therefore, the projection 7b of the head portion press member 7 and the notch 28c of the spring fixing portion 28b engage with each other, thereby upwardly rotating the head portion 2b. Consequently, the head portion 2b having been pressed against the platen roller 3 (see FIG. 1) separates from the platen roller 3 upon rotation of the head portion press member 7.

The feed roller bearings 12 and 13 rotatably support the feed roller 9 of metal, as shown in FIG. 2. The feed roller 9 is provided on a first end thereof with a feed roller gear insert portion 9a (see FIG. 4) inserted into the feed roller gear 10. The press roller bearings 14 rotatably support the press roller 11 of metal, as shown in FIG. 2. The press roller bearings 14 are mounted on the bearing support plates 15 provided inside the bent section if provided on the bottom surface 1c of the chassis 1 and the second side surface 1b thereof respectively. As shown in FIG. 1, the bearing support plates 15 are provided inside the bent section 1f provided on the bottom surface 1c of the chassis 1 and the second side surface 1b thereof respectively, to be rotatable about support portions 15a. Second ends of the helical tension springs 16 for urging the press roller 11 toward the feed roller 9 are mounted on spring mount portions 15b of the bearing support plates 15.

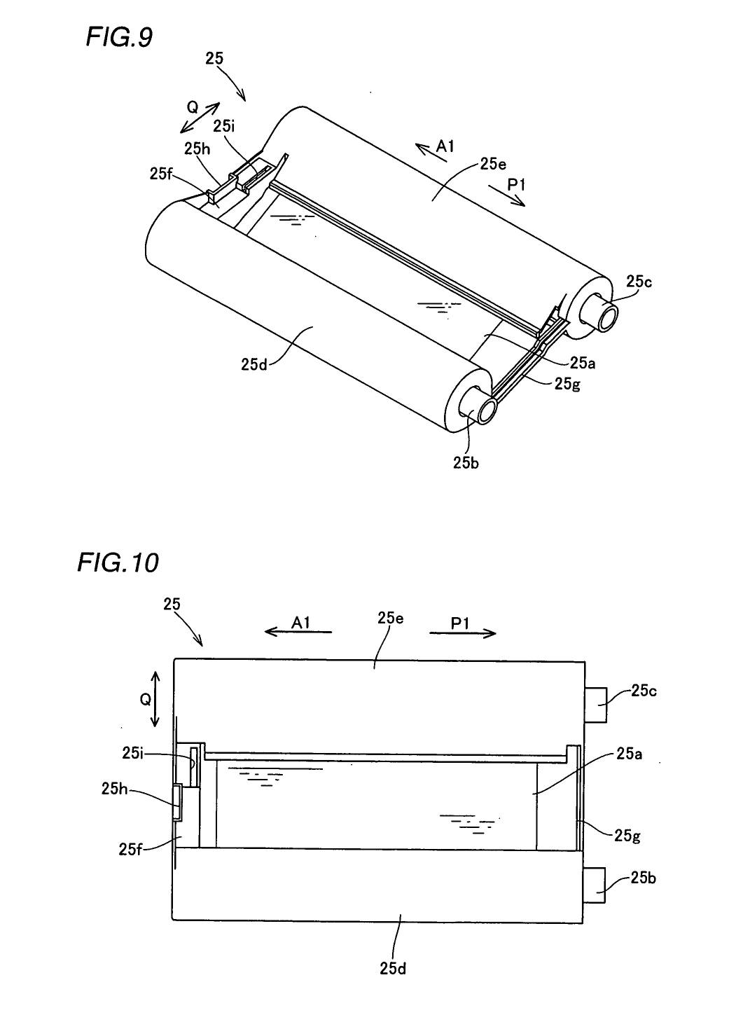

As shown in FIG. 12, the ink sheet cartridge 25 includes a feed bobbin 25b for feeding the ink sheets 25a and a take-up bobbin 25c for taking up the fed ink sheets 25a. A cartridge case forming the ink sheet cartridge 25 is constituted of a feed bobbin storage portion 25d rotatably storing the feed bobbin 25b, a take-up bobbin storage portion 25e rotatably storing the take-up bobbin 25c and a pair of coupling portions 25f and 25g coupling the feed bobbin storage portion 25d and the take-up bobbin storage portion 25e with each other at a prescribed distance, as shown in FIGS. 9 to 11. When the feed bobbin storage portion 25d and the take-up bobbin storage portion 25e store the feed bobbin 25b and the take-up bobbin 25c respectively, therefore, the ink sheets 25a wound on the feed bobbin 25b and the take-up bobbin 25c are outwardly exposed on the space of the prescribed distance between the feed bobbin storage portion 25d and the take-up bobbin storage portion 25e. The ink sheets 25a are constituted of those of three colors, i.e., Y (yellow), M (magenta) and C (cyan) ink sheets 25a. As shown in FIGS. 5 and 9, the coupling portion 25f is provided with the engaging portion 25h engaging with the stop member 27 provided on the first side surface 1a of the chassis 1. As shown in FIG. 12, the ink sheet cartridge 25 is provided with helical compression springs 25j regularly urging the ink sheet cartridge 25 mounted on the thermal transfer printer in the ejective direction along arrow A1 in FIG. 5.

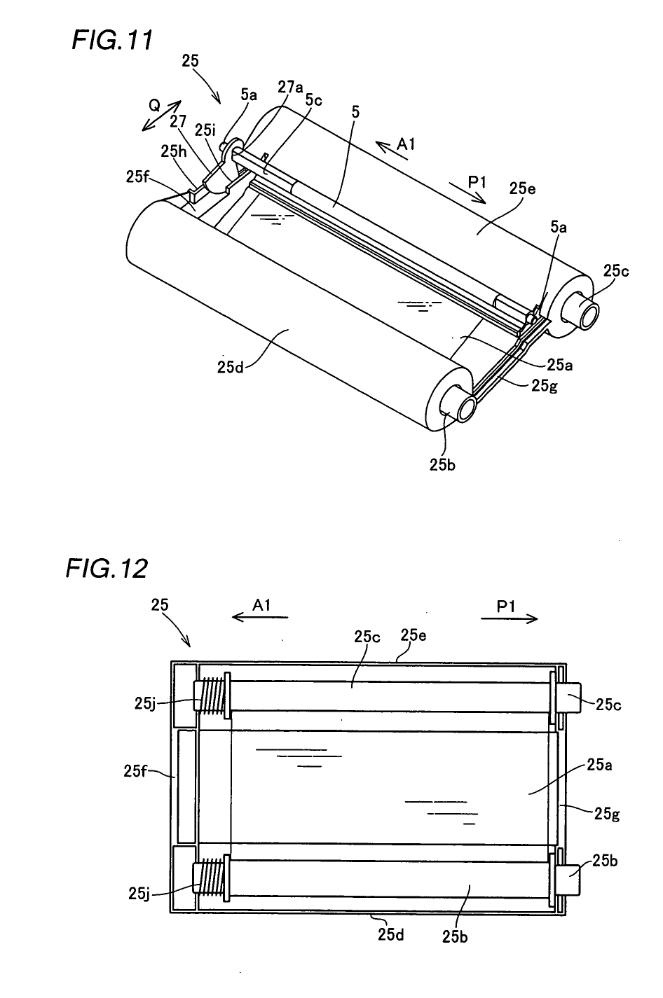

According to this embodiment, a slender groove portion (engaging portion) 25i is provided on the upper surface of the coupling portion 25f of the ink sheet cartridge 25 for engaging with the stop member 27, as shown in FIGS. 9 and 10. This groove portion 25i extends parallelly to the extensional direction (along arrow Q in FIG. 10) of the coupling portion 25f. The width of the groove portion 25i is rendered slightly larger than the thickness of the stop member 27. When the stop member 27 is inserted into the groove portion 25i, therefore, the groove portion 25i engages with both surfaces of the stop member 27 as shown in FIG. 11.

The take-up reel 24 (see FIG. 4) engages with the take-up bobbin 25c arranged in the take-up bobbin storage portion 25e of the ink sheet cartridge 25 (see FIG. 9), thereby taking up the ink sheets 25a wound on the take-up bobbin 25. As shown in FIG. 4, the gear portion 24a of the take-up reel 24 meshes with the swing gear 21 swinging along arrow X.

As shown in FIG. 4, further, the paper feed motor 18 driving the feed roller 9 and the take-up reel 24 is mounted on the motor bracket 17 through the motor gear 18a and the intermediate gears 22 and 23. The press member rotating motor 19 vertically rotating the head portion press members 6 and 7 is mounted on the motor bracket 17. A small-diametral gear portion 201a of the drive gear 20a meshes with the gear portion 6b of the head portion press member 6 as shown in FIG. 2, while a large-diametral gear portion 202a thereof meshes with a small-diametral gear 201b of the intermediate gear 20b as shown in FIG. 1. A large-diametral gear 202b of the intermediate gear 20b meshes with the motor gear 19a of the press member rotating motor 19. Thus, driving of the press member rotating motor 19 is transmitted to the head portion press member 6 through the intermediate gear 20b and the drive gear 20a.

A printing operation of the thermal transfer printer according to this embodiment is now described with reference to FIGS. 1, 2, 4, 5 and 13 to 18.

In an initial state, the thermal transfer printer holds the head portion 2b of the print head 2 at a position separated from the platen roller 3, as shown in FIG. 13. At this time, the projection 7b of the head portion press member 7 engages with the notch 28c of the engaging portion 28d of the spring fixing portion 28b provided on the head portion 2b, thereby inhibiting the head portion 2b from rotation along arrow D1 in FIG. 13. The thermal transfer printer regularly urges the ink sheet cartridge 25 along arrow A1 in FIG. 5, and inhibits the same from movement along arrow A1 due to the engagement between the engaging portion 25h of the ink sheet cartridge 25 and the engaging pawl 26c of the stop portion 26a, as shown in FIG. 5.

When the thermal transfer printer drives the press member rotating motor 19 (see FIG. 4) from the initial state shown in FIG. 13, the driving force thereof is transmitted to the gear portion 6a of the head portion press member 6 through the intermediate gear 20b (see FIG. 2) and the drive gear 20a, thereby rotating the head portion press member 6 about the support rod 5 along arrow E1. At this time, the head portion press member 7 also rotates along arrow E1 with the head portion press member 6, since the head portion press members 6 and 7 (see FIG. 2) do not idle with respect to the support rod 5. The projection 7b of the head portion press member 7 so rotates along arrow E1 that the head portion 2b, having been controlled through the projection 7b not to rotate along arrow D 1, also rotates along arrow D1. Thus, the head portion 2b moves toward the platen roller 3 (press side), as shown in FIG. 13. The stop member 27 also rotates along arrow E1 following the rotation of the head portion press members 6 and 7, as shown in FIG. 14.

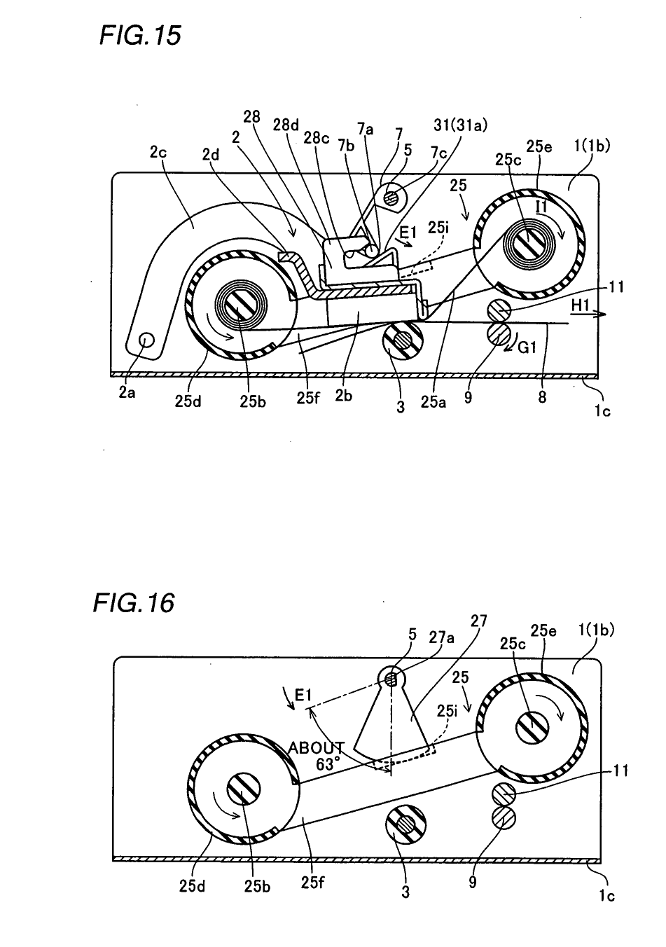

While the print head 2 moves to a press position shown in FIG. 15, the head portion press members 6 and 7 further rotate along arrow E1.

Attorney Docket: 102238.57836US Thus, the press portion 6a of the head portion press member 6 presses the first end 30a of the torsion coil spring 30 arranged on the spring holder 28. Further, the press portion 7a of the head portion press member 7 also presses the first end 31a of the torsion coil spring 31 arranged on the spring holder 28. At this time, the torsion coil springs 30 and 31 cause urging force, which in turn is transmitted to the head portion 2b through the second ends 30b and 31b of the torsion coil springs 30 and 31 respectively. Thus, the head portion 2b is urged toward the platen roller 30 through the paper 8 and the Y ink sheet 25a. The head portion 2b generates heat, to melt ink of the Y ink sheet 25a and transfer the same to the paper 8.

As shown in FIG. 4, the thermal transfer printer drives the paper feed motor 18 to rotate the motor gear 18a mounted thereon along arrow F1, thereby rotating the feed roller gear 10 along arrow G1 through the intermediate gears 22 and 23. Thus, the feed roller 9 rotates along arrow G1 following the rotation of the feed roller gear 10 (see FIG. 4) as shown in FIG. 15, thereby carrying the paper 8 in a paper discharge direction (along arrow H1 in FIG. 15). The swingable swing gear 21 (see FIG. 4) swings along arrow X in FIG. 4, to mesh with the gear portion 24a of the take-up reel 24. Therefore, the gear portion 24a of the take-up reel 24 rotates along arrow I1 in FIG. 4, so that the take-up bobbin 25c takes up the Y ink sheet wound on the feed bobbin 25b. Thus, the ink is continuously transferred from the Y ink sheet 25a to the paper 8.

As shown in FIG. 16, the stop member 27 rotates along arrow E1 by about 630 from the initial position of the print head 2 following the rotation of the head portion press members 6 and 7. In this state, the core of the stop member 27 is perpendicular. In printing, the stop member 27 engages with the groove portion 25i of the ink sheet cartridge 25, as shown in FIG. 16.

According to this embodiment, the thermal transfer printer inhibits the ink sheet cartridge 25 from movement in the ejective direction (along arrow A1 in FIG. 5) not only through the stop portion 26a provided outside the second side surface 1b of the chassis 1 but also through the stop member 27 provided inside the second side surface 1b of the chassis 1, due to the engagement between the stop member 27 and the groove portion 25i of the ink sheet cartridge 25. Also when the user manually operates the stop portion 26a provided outside the second side surface 1b of the chassis 1 for ejecting the ink sheet cartridge 25, therefore, the thermal transfer printer inhibits the ink sheet cartridge 25 from movement in the ejective direction (along arrow A1 in FIG. 5) due to the engagement between the stop member 27 provided inside the second side surface 1b of the chassis 1 and the groove portion 25i of the ink sheet cartridge 25.

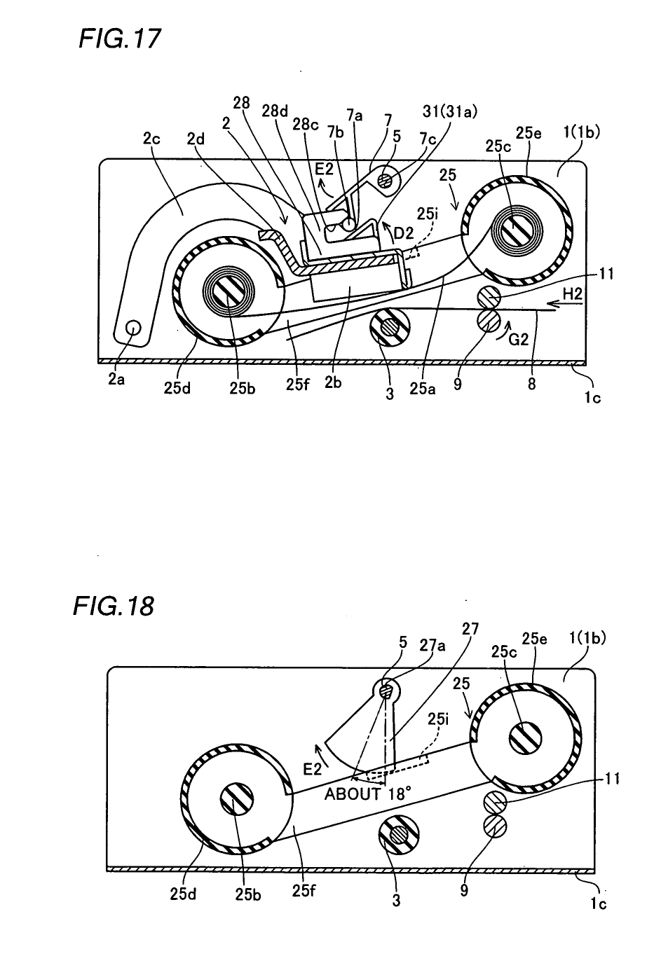

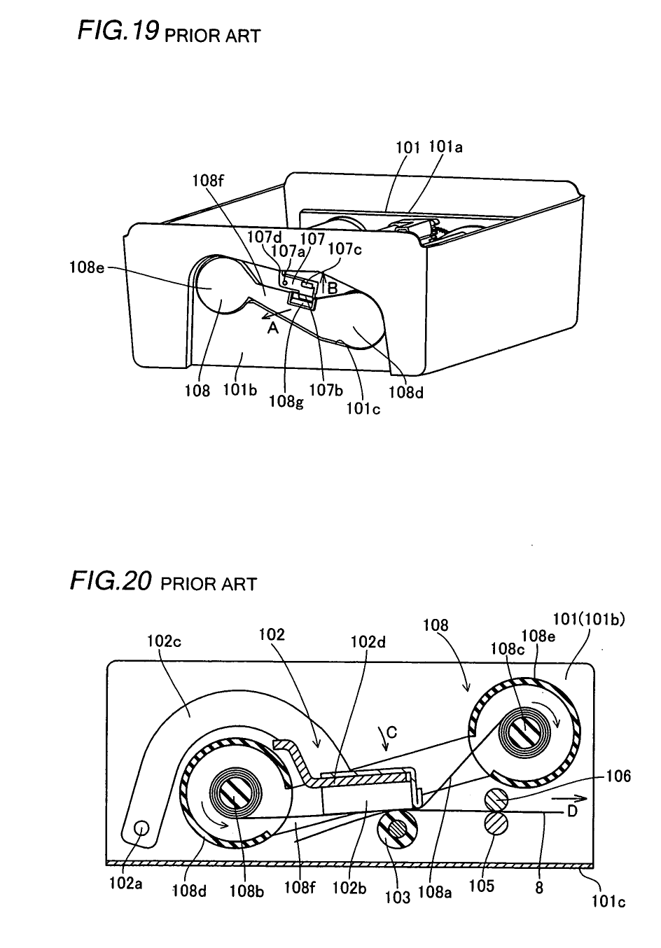

Upon completion of printing of the Y (yellow) ink sheet 25a, the thermal transfer printer drives the press member rotating motor 19 (see FIG. 4) so that the driving force thereof is transmitted to the gear portion 6a of the head portion press member 6 through the intermediate gear 20b (see FIG. 1) and the drive gear 20a. Thus, the head portion press member 6 rotates about the support rod 5 along arrow E2 in FIG. 17. At this time, the head portion press member 7 also rotates along arrow E2 as shown in FIG. 17, since the head portion press members 6 and 7 (see FIG. 2) do not idle with respect to the support rod 5. The projection 7b of the head portion press member 7 rotates along arrow E2 to lift up the notch 28c of the spring holder 28 of the print head 2 engaging with the projection 7b, thereby rotating the head portion 2b of the print head 2 along arrow D2. Thus, the head portion 2b of the print head 2 separates from the platen roller 3. As shown in FIG. 18, the stop member 27 rotates along arrow E2 by about 180 following the rotation of the head portion press members 6 and 7. According to this embodiment, the stop member 27 is still in engagement with the slender groove portion 25i after the head portion 2b of the print head 2 separates from the platen roller 3.

As shown in FIG. 4, the thermal transfer printer drives the paper feed motor 18 to rotate the motor gear 18a mounted thereon along arrow F2, thereby rotating the feed roller gear 10 along arrow G2 through the intermediate gears 22 and 23. Thus, the feed roller 9 rotates along arrow G2 following the rotation of the feed roller gear 10 (see FIG. 4) as shown in FIG. 17, thereby carrying the paper 8 in a paper feed direction (along arrow H2 in FIG. 17) again. The swingable swing gear 21 (see FIG. 4) swings along arrow Y in FIG. 4, to separate from the gear portion 24a of the take-up reel 24. Thus, the thermal transfer printer carries only the paper 8 in the paper feed direction without taking up the Y ink sheet 25a wound on the feed bobbin 25b on the take-up bobbin 25c.

Thereafter the thermal transfer printer performs operations similar to the above on the M and C ink sheets 25a. When completely printing the Y, M and C ink sheets 25a, the thermal transfer printer carries the paper 8 in the paper discharge direction (along arrow H1 in FIG. 13). Then, the head portion 2b of the print head 2b rotates to the initial position as shown in FIG. 13, thereby completing printing on the paper 8. When the head portion 2b of the print head 2 is on the initial position, the stop member 27 and the groove portion 25i of the ink sheet cartridge 25 are in disengagement from each other, and only the stop portion 26a inhibits the ink sheet cartridge 25 from movement in the ejective direction (along arrow A1 in FIG. 5).

According to this embodiment, as hereinabove described, the stop portion 26a is provided outside the chassis 1 while the stop member 27 engaging with the ink sheet cartridge 25 in printing is provided inside the chassis 1 so that the stop member 27 and the ink sheet cartridge 25 remain engaging with each other in the chassis 1 also when the user disengages the stop portion 26a provided outside the chassis 1 and the ink sheet cartridge 25 from each other in printing, whereby the thermal transfer printer can suppress ejection of the ink sheet cartridge 25 in printing. Consequently, the thermal transfer printer can suppress breakage of the ink sheets 25a, and can prevent a failure resulting from entanglement of the ink sheets 25a therein.

According to this embodiment, the stop member 27 is so provided inside the chassis 1 that the user can be inhibited from touching the stop member 27, whereby the thermal transfer printer can prevent the second stop member 27 from application of a load in printing. Thus, the thermal transfer printer can prevent the members provided inside the chassis 1 from application of a load in printing, thereby suppressing reduction of printing quality.

According to this embodiment, the stop member 27 is mounted on the support rod 5 to be rotatable following rotation of the head portion press members 6 and 7 rotating the print head 2 in printing, whereby the stop member 27 can engage with the ink sheet cartridge 25 in printing without a dedicated drive source. Consequently, the thermal transfer printer can easily suppress ejection of the ink sheet cartridge 25 in printing.

According to this embodiment, the ink sheet cartridge 25 is provided with the groove portion 25i engaging with both surfaces of the stop member 27, whereby the thermal transfer printer can inhibit the ink sheet cartridge 25 from movement not only in the ejective direction (along arrow A1 in FIG. 2) but also in a direction (along arrow P1 in FIG. 2) opposite thereto. Thus, the thermal transfer printer can suppress reduction of printing quality resulting from misregistration in the direction (along arrow P1 in FIG. 2) opposite to the ejective direction for the ink sheets 25a.

According to this embodiment, the stop member 27 rotates following rotation of the print head 2 to engage with the groove portion 25i when the print head 2 vertically rotates for printing the ink sheets 25a of a plurality of colors, whereby the thermal transfer printer can suppress ejection of the ink sheet cartridge 25 also when the user disengages the stop portion 26a and the ink sheet cartridge 25 from each other while the print head 2 separates from the platen roller 3 upon completion of printing in each color. Thus, the thermal transfer printer can suppress imperfect completion of printing resulting from ejection of the ink sheet cartridge 25 in an intermediate stage of printing in each color.

According to this embodiment, the groove portion 25i provide on the coupling portion 25f of the ink sheet cartridge 25 is so located around a central portion between the take-up bobbin storage portion 25e and the feed bobbin storage portion 25d that the stop portion 27 can engage with the groove portion 25i around the central portion between the take-up bobbin storage portion 25e and the feed bobbin storage portion 25d. Therefore, the stop member 27 can inhibit the ink sheet cartridge 25 from movement around the central portion between the take-up bobbin storage portion 25e and the feed bobbin storage portion 25d of the ink sheet cartridge 25, whereby the thermal transfer printer can more stably inhibit the ink sheet cartridge 25 from movement as compared with a case of inhibiting the ink sheet cartridge 25 from movement on the side of the feed bobbin storage portion 25d or the take-up bobbin storage portion 25e.

According to this embodiment, the portion of the stop member 27 engaging with the ink sheet cartridge 25 is arcuately formed, whereby the stop member 27 can so easily partially engage with the engaging portion 25i that the thermal transfer printer can easily keep the stop member 27 and the groove portion 25i in engagement also when the print head 2 vertically rotates in printing.

According to this embodiment, the groove portion 25i of the ink sheet cartridge 25 has a slender form, whereby the thermal transfer printer can so increase the area of the groove portion 25i engaging with the stop member 27 as to inhibit the stop member 27 from disengaging from the slender groove portion 25i when the print head 2 rotates to separate from the platen roller 3 upon completion of printing in each color. Thus, the thermal transfer printer can easily engage the stop member 27 with the groove portion 25i also when the print head 2 separates from the platen roller 3 upon completion of printing in each color.

Although the present invention has been described and illustrated in detail, it is clearly understood that the same is by way of illustration and example only and is not to be taken by way of limitation, the spirit and scope of the present invention being limited only by the terms of the appended claims.

For example, while the aforementioned embodiment is applied to the thermal transfer printer, the present invention is not restricted to this but is also applicable to another image generating apparatus other than the thermal transfer printer.

While the groove portion is provided on one of the coupling portions of the ink sheet cartridge in the aforementioned embodiment, the present invention is not restricted to this but the groove portion may alternatively be provided on a position other than the coupling portion of the ink sheet cartridge. For example, the groove portion may be provided on the take-up bobbin storage portion. while the groove portion engaging with the stop member is provided on one of the coupling portions of the ink sheet cartridge in the aforementioned embodiment, the present invention is not restricted to this but an engaging portion other than the groove portion may alternatively be provided on the ink sheet cartridge so far as the same can engage with the stop member for inhibiting the ink sheet cartridge from movement in the ejective direction. For example, a boss engaging with the stop member may be provided on the ink sheet cartridge. Further, the stop member may be provided in the form of a groove, and the ink sheet cartridge may be formed with a projecting portion engaging with the groove-shaped stop member.

While the angle of the arcuately formed portion of the stop member is set to about 40° in the aforementioned embodiment, the present invention is not restricted to this but the arcuately formed portion of the stop member may alternatively be at an angle other than 40°.

While the thermal transfer printer is provided with the arcuate stop member in the aforementioned embodiment, the present invention is not restricted to this but the thermal transfer printer may alternatively be provided with a stop member having a shape other than the arcuate shape so far as the same can engage with the ink sheet cartridge.

What is claimed is:

1. An image generating apparatus comprising:
an ink sheet cartridge including a cartridge case provided with a feed bobbin storage portion and a take-up bobbin storage portion coupled with each other through a pair of coupling portions at a prescribed interval, a feed bobbin and a take-up bobbin stored in said cartridge case and an ink sheet outwardly exposed between said feed bobbin storage portion and said take-up bobbin storage portion;
a chassis mounted with said ink sheet cartridge;
a first stop member provided outside said chassis for engaging with said ink sheet cartridge; and
a second stop member provided inside said chassis for engaging with said ink sheet cartridge in printing.

2. The image generating apparatus according to claim 1, further comprising a print head for printing, a platen roller arranged on a position opposite to said print head and a press member pressing said print head against said platen roller, wherein
said second stop member is mounted on a rotating shaft of said press member.

3. The image generating apparatus according to claim 2, wherein
said second stop member is unidly mounted with respect to said rotating shaft.

4. The image generating apparatus according to claim 3, wherein
an oval stop member insert portion is provided on a portion of said rotating shaft mounted with said second stop member, and
an oval rotating shaft receiving hole is provided on a portion of said second stop member receiving said rotating shaft.

5. The image generating apparatus according to claim 1, wherein
said ink sheet cartridge is provided with an engaging portion engaging with said second stop member.

6. The image generating apparatus according to claim 5, wherein
said engaging portion of said ink sheet cartridge includes a groove portion engaging with both surfaces of said second stop member.

7. The image generating apparatus according to claim 6, wherein
said ink sheet cartridge further includes multicolor said ink sheet, and
said second stop member rotates following rotation of said print head, and engages with said groove portion while said print head vertically rotates for printing said multicolor ink sheet.

8. The image generating apparatus according to claim 7, wherein
said groove portion has a slender shape.

9. The image generating apparatus according to claim 6, wherein
said groove portion is provided on either said coupling portion of said ink sheet cartridge.

10. The image generating apparatus according to claim 5, wherein
a portion of said second stop member engaging with said engaging portion of said ink sheet cartridge is arcuately formed.

11. An image generating apparatus comprising:
an ink sheet cartridge including a cartridge case provided with a feed bobbin storage portion and a take-up bobbin storage portion coupled with each other through a pair of coupling portions at a prescribed interval,. a feed bobbin and a take-up bobbin stored in said cartridge case and a multicolor ink sheet outwardly exposed between said feed bobbin storage portion and said take-up bobbin storage portion;
a chassis mounted with said ink sheet cartridge;
a print head for printing;
a platen roller arranged on a position opposite to said print head;
a press member pressing said print head against said platen roller;
a first stop member provided outside said chassis for engaging with said ink sheet cartridge; and
a second stop member provided inside said chassis for engaging with said ink sheet cartridge in printing, wherein
said ink sheet cartridge is provided with a groove portion engaging with both surfaces of said second stop member,
said groove portion is provided on either said coupling portion of said ink sheet cartridge;
said second stop member is mounted on a rotating shaft of said press member for rotating following rotation of said print head and engaging with said groove portion while said print head vertically rotates for printing said multicolor ink sheet, and
a portion of said second stop member engaging with said ink sheet cartridge is arcuately formed.

12. The image generating apparatus according to claim 11, wherein
said second stop member is unidly mounted with respect to said rotating shaft.

13. The image generating apparatus according to claim 12, wherein
an oval stop member insert portion is provided on a portion of said rotating shaft mounted with said second stop member, and
an oval rotating shaft receiving hole is provided on a portion of said second stop member receiving said rotating shaft.

14. The image generating apparatus according to claim 11, wherein
said groove portion has a slender shape.
